(19) United States
(12) Patent Application Publication
(10) Pub. No.: US 2010/0061219 A1
(43) Pub. Date: Mar. 11, 2010

(54) VIBRATION REDUCTION APPARATUS AND DISK DRIVE USING THE SAME

(76) Inventors: Wook Young Soh, Seoul (KR); No-Cheol Park, Seoul (KR); Han Baek Lee, Seoul (KR); Young-Pil Park, Seoul (KR); Seung-Ho Lim, Seoul (KR)

Correspondence Address: KED & ASSOCIATES, LLP, P.O. Box 221200, Chantilly, VA, 20153-1200, US

(21) Appl. No.: 12/548,726

(22) Filed: Aug. 27, 2009

(30) Foreign Application Priority Data
Sep. 11, 2008 (KR) 10-2008-0089934

(51) Int. Cl. G11B 23/00

(52) U.S. Cl. 369/263.1; G9B/23

(57) ABSTRACT

A vibration reduction apparatus of a disk drive is provided. An optical pickup base 10 in which an optical pickup 16 is movably installed is provided. A spindle motor 18 for providing power requiring for rotating a disk is installed at the front end of the optical pickup base 10, and a turntable 20 for mounting a disk is provided at a rotation axis of the spindle motor 18. A vibration reduction body 30 for reducing a vibration generating in the optical pickup base 10 is installed in the optical pickup base 10. The vibration reduction body 30 comprises a fixing device 32 fixedly installed at one side of the optical pickup base 10, a support bar 36 extended from one side of the fixing device 32 and having an elastically deformable cantilever shape, and a vibration proof weight 38 provided at the front end of the support bar 36. Thereby, the vibration reduction body is formed with one module and can be installed at a location having a large vibration response according to a design condition, thereby effectively reducing a vibration.

This application claims the benefit of Korean Patent Application No. 10-2008-0089934 filed on Sep. 11, 2008, which is hereby incorporated by reference.

### BACKGROUND

1. Field

This document relates to a vibration reduction apparatus and a disk drive using the same.

2. Related Art

In general, a disk drive indicates an optical device storage medium using an optical pickup. The disk drive is classified into a compact disc read-only memory (CD-ROM), a compact disc rewritable (CD-RW), and a digital versatile disc rewritable (DVD-RW). As a method of inserting a record medium into a disk drive, a tray type has generally been used. The tray type has a form in which a disk drive is mounted in a computer body and in which a support for housing a record medium is exposed to the outside of the main body.

Nowadays, as interest on a product of an integral structure of a monitor and a television and of an integral structure of a liquid crystal display and a personal computer has increased, such a product has been developed. In a portable computer such as a notebook computer, the computer of a slim design form of directly inserting a disk drive into the computer is generally used.

As described above, because it is difficult to use a tray type in order to sustain a slim design form, a slot type desk drive is used. That is, the slot type desk drive uses a method of inserting a record medium into a disk drive without a tray for putting the record medium.

In general, an optical pickup for radiating light to a signal record surface of a disk is movably installed in the disk drive. The optical pickup performs a function of reading a recorded signal, or recording a signal by radiating light to the signal record surface of the disk.

### SUMMARY

An aspect of this document is to provide a vibration reduction apparatus of a disk drive having a structure of reducing a vibration generating when rotating a disk by eccentricity or deflection of the disk.

Another aspect of this document is to provide a vibration reduction apparatus of a disk drive that can be used for disk drives of various structures and kinds.

The objects of this document are not limited to the above-described objects and the other objects will be understood by those skilled in the art from the following description.

### BRIEF DESCRIPTION OF THE DRAWINGS

The accompany drawings, which are comprised to provide a further understanding of the invention and are incorporated on and constitute a part of this specification illustrate embodiments of the invention and together with the description serve to explain the principles of the invention.

FIG. 1 is a perspective view illustrating a configuration of a vibration reduction apparatus of a disk drive in an implementation of this document;

FIG. 2 is a cross-sectional view illustrating a configuration of a vibration reduction apparatus of a disk drive in an implementation of this document;

FIG. 3 is a graph comparing frequency responses of a vibration reduction apparatus of a disk drive of this document;

FIGS. 4 and 5 are perspective views illustrating a configuration of a vibration reduction apparatus of a disk drive in another implementation of this document; and

FIG. 6 is a perspective view illustrating a configuration of a vibration reduction apparatus of a disk drive in another implementation of this document.

### DETAILED DESCRIPTION

Reference will now be made in detail embodiments of the invention examples of which are illustrated in the accompanying drawings.

Hereinafter, implementations of a vibration reduction apparatus of a disk drive of this document will be described in detail with reference to the accompanying drawings.

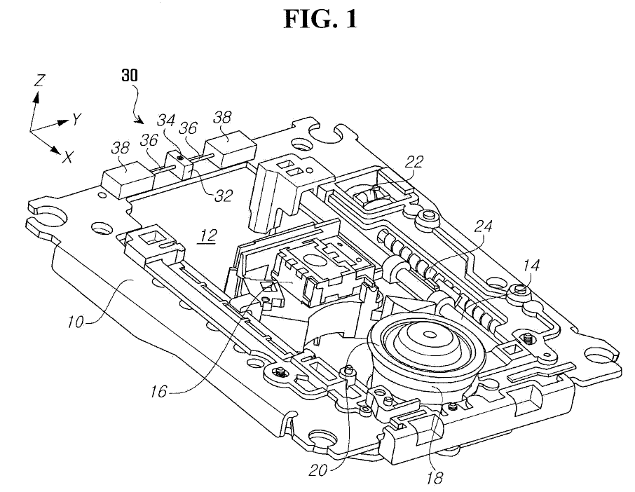

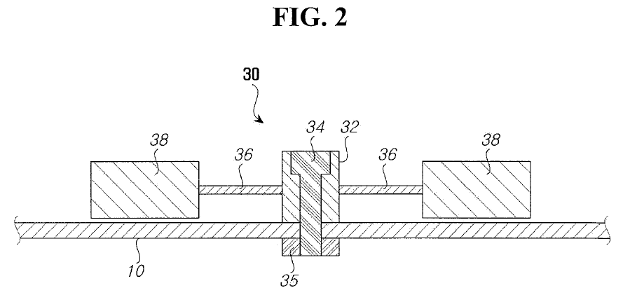

FIG. 1 is a perspective view illustrating a configuration of an implementation of a vibration reduction apparatus of a disk drive of this document, and FIG. 2 is a cross-sectional view illustrating a configuration of an implementation of a vibration reduction apparatus of a disk drive of this document.

Referring to FIGS. 1 and 2, the front end of an optical pickup base 10 is installed to move upward and downward in a main base (not shown). This is not to interfere with a disk tray (not shown) when loading and ejecting a disk.

An optical pickup transfer window 12 having a predetermined length and width is formed to vertically open in the optical pickup base 10. The optical pickup transfer window 12 is formed in approximately a rectangular shape. The optical pickup transfer window 12 is a portion in which an optical pickup 16 to be described later performs a linear reciprocating motion.

Each guide axis 14 is provided at both sides of the optical pickup transfer window 12. A pair of guide axes 14 are installed in parallel. The optical pickup 16 is movably installed in the guide axis 14. Both sides of the optical pickup 16 are supportably installed in the guide axis 14 and the optical pickup 16 radiates light to a disk while performing a linear reciprocating motion in the optical pickup transfer window 12. The optical pickup 16 performs a function of reading or recording a signal recorded in a signal record surface of the disk by radiating light to the disk.

A spindle motor 18 is installed at the front end of the optical pickup base 10. The spindle motor 18 performs a function of providing power requiring for rotating the disk. A turntable 20 for mounting the disk is provided in a rotation axis of the spindle motor 18. The turntable 20 rotates together with the disk by power of the spindle motor 18 in a state where the disk is mounted.

A sled motor 22 is installed at one side of the optical pickup base 10. The sled motor 22 performs a function of providing power requiring for moving the optical pickup 16. A lead screw 24 is provided in a rotation axis of the sled motor 22. The lead screw 24 engages with a feed guide (not shown) provided in a side surface of the optical pickup 16. Therefore, when the sled motor 22 is driven, the lead screw 24 rotates and the optical pickup 16 radiates light to the disk while performing a linear reciprocating motion along the optical pickup transfer window 12.

A vibration reduction body 30 is installed at one side of an upper surface of the optical pickup base 10. The vibration reduction body 30 performs a function of reducing a vibration generating by eccentricity or deflection of the disk. In general, most disks have predetermined eccentricity or deflection due to an error in a manufacturing process. For example, one side of the disk may have a radius shorter or longer than a design reference based on a center hole of the disk. In such a case, both sides of the disk may have a different weight based on the center hole of the disk, and such a weight difference causes an excessive vibration response when the disk rotates in a high speed and thus a vibration generates in the optical pickup base 10.

The vibration reduction body 30 is to efficiently reduce an excessive vibration response due to the above-described eccentricity or deflection of the disk. The vibration reduction body 30 is formed with one module and can be installed at various locations according to a vibration response. Therefore, by installing the vibration reduction body 30 at a location having a large vibration response, vibration reduction can be maximized.

In this implementation, it is preferable that the vibration reduction body 30 is provided at the rear end of the optical pickup base 10 having an allowable installing space, compared with other portions. However, the vibration reduction body 30 may be installed at an appropriate location such as both sides of the optical pickup base 10.

A fixing device 32 is provided in the vibration reduction body 30. The fixing device 32 is fixedly installed in a surface of the optical pickup base 10 to function as the center of gravity of the vibration reduction body 30. The fixing device 32 may be formed integrally with the optical pickup base 10.

The fixing device 32 is fastened to the optical pickup base 10 by a volt 34 and a nut 35. That is, the volt 34 penetrating through the fixing device 32 and the optical pickup base 10 is fastened to the nut 35 to fix the fixing device 32. The fixing device 32 can be fixed by a fastening device other than the volt 34 and the nut 35.

Each support bar 36 is extended at both sides of the fixing device 32. The support bar 36 is formed in approximately a cantilever shape and can be elastically deformed. The support bars 36 are extended in symmetry at both sides of the fixing device 32.

Each vibration proof weight 38 is provided at the front end of the support bar 36. The vibration proof weight 38 has a predetermined weight, is made of a metal material having high specific gravity, and is made of a material that can increase a weight while having a less volume, but a material of the vibration proof weight 38 is not limited to a metal. The vibration proof weight 38 is supported by the support bar 36 with separated by a predetermined distance from an upper surface of the optical pickup base 10. Therefore, the vibration proof weight 38 absorbs a vibration transferred to the support bar 36 that can be elastically deformed when vibrating. In this implementation, the vibration proof weight 38 has a rectangular shape, but a shape of the vibration proof weight 38 is not limited thereto and the vibration proof weight 38 can have various shapes. Further, the vibration proof weight 38 may be formed by coupling several pieces.

In this implementation, the vibration reduction body 30 is designed in consideration of the following conditions. That is, the vibration reduction body 30 is designed in consideration of one or an appropriate combination of a length, a sectional shape, and a Young's modulus of the support bar 36 and a location and a weight of the vibration proof weight 38. When the vibration reduction body 30 is designed in consideration of the above conditions, a natural frequency of the optical pickup base 10 is escaped, and thus a resonance can be prevented from occurring.

This is described in detail as follows. When it is assumed that other conditions are identical, if a length of the support bar 36 is extended, an amplitude of the vibrating support bar 36 increases and a vibration frequency decreases. Alternatively, if a length of the support bar 36 is shortened, an amplitude of the vibrating support bar 36 decreases and a vibration frequency increases. Accordingly, if a length of the support bar 36 is extended, the optical pickup base 10 can derive a change of a vibrating frequency range. That is, when it is assumed that a natural frequency of the optical pickup base 10 is 210 Hz, if the optical pickup base 10 vibrates with a natural frequency of 210 Hz, a resonance occurs. Therefore, in this case, by changing a vibration of the optical pickup base 10 to 210 Hz or less using the vibration reduction body 30 having the support bar 36 of a relatively long length, a resonance can be suppressed from occurring. Such a change of a frequency range can be derived by appropriately combining the above-described elements such as a length of the support bar 36.

Further, the vibration reduction body 30 is designed according to a double speed of a disk, thereby minimizing a vibration. For example, when the disk operates in a high double speed, by more shortening a length of the support bar 36, rigidity of the disk increases, and when the disk operates in a low double speed, by extending a length of the support bar 36, rigidity of the disk decreases.

In this implementation, the vibration proof weight 38 can reduce a vibration generating in X-axis and Z-axis directions shown in FIG. 1. Further, in order to reduce a vibration of a Y-axis direction, which is an extension direction of the support bar 36, the vibration proof weight 38 may be provided in a direction perpendicular to an extension direction of the support bar 36. The vibration reduction body 30 is not limited to a configuration shown in FIGS. 1 and 2. That is, a configuration of disposing two fixing devices 32 at the vibration reduction body 30 and supporting the vibration proof weights 38 by the support bar 36 at a location between the fixing devices 32 and at both sides may be formed. In this case, total three vibration proof weights 38 are provided to reduce a vibration of the optical pickup base 10.

An operation of a vibration reduction apparatus of a disk drive of this document having the above-described configuration is described in detail.

When a disk reproduction signal is input to the disk drive of this document, the spindle motor 18 is driven and thus the turntable 20 rotates together with the disk. The lead screw 24 rotates by driving of the sled motor 22, and the optical pickup 16 radiates light to a signal record surface of the disk while moving in the optical pickup transfer window 12 by interlocking with a rotation of the lead screw 24.

In this way, in a process where the disk is reproduced and rotates with a high speed, a vibration may generate in the optical pickup base 10 by eccentricity and deflection of the disk. As shown in FIG. 1, a vibration may generate in X-axis and Z-axis directions in the optical pickup base 10. In this case, a vibration generated in the optical pickup base 10 can be reduced by the vibration proof weight 38.

For example, when a vibration generates in a Y-axis direction in the optical pickup base 10, the vibration proof weight 38 is connected to the elastically deformable support bar 36, and thus the vibration reduction body 30 absorbs a vibration generated in the optical pickup base 10 while vibrating in a Y-axis direction. Because the vibration proof weight 38 has a predetermined weight, the vibration proof weight 38 absorbs a vibration received through the support bar 36, thereby minimizing a vibration.

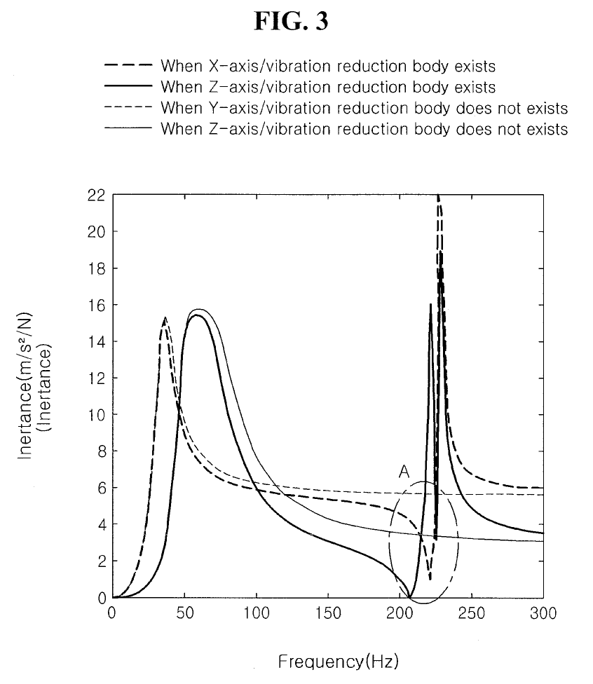

FIG. 3 is a graph comparing frequency responses of a vibration reduction apparatus of a disk drive of this document. The graph compares cases where the vibration reduction body 30 of this document exists and does not exist and compares the results when a vibration generates in X-axis and Z-axis directions.

In the graph, it can be seen that when the vibration reduction body 30 exists, an entirely small vibration generates, compared with when the vibration reduction body 30 does not exist. Particularly, a remarkable vibration difference exists in a frequency range indicated as an area A. It can be seen that a vibration of a Z-axis direction is entirely remarkably reduced, compared with a vibration of an X-axis direction. This is because the vibration proof weight 38 of the vibration reduction body 30 is supported in a gravity direction, a Z-axis vibration of a gravity direction is more effectively attenuated.

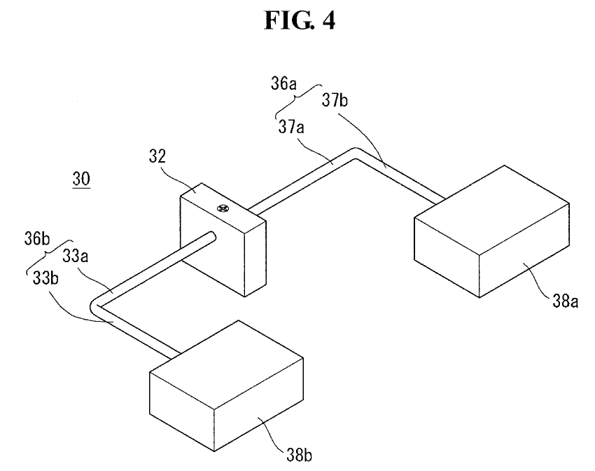

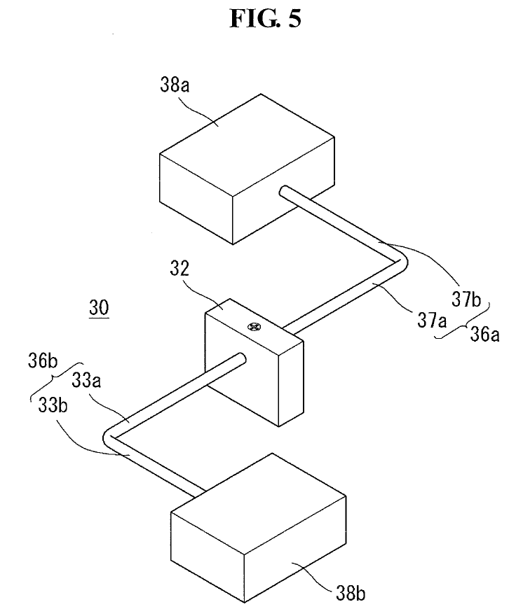

FIGS. 4 and 5 are perspective views illustrating a configuration of a vibration reduction apparatus of a disk drive in another implementation of this document. As shown in FIG. 4, first and second support bars 36a and 36b of a bent shape are provided in the vibration reduction apparatus 30 in another implementation of this document.

Specifically, in the first support bar 36a, a linear portion 37a is extended from the fixing device 32. The linear portion 37a extended from the fixing device 32 is bent in a substantially orthogonal direction from a bending portion 37b. FIG. 4 illustrates the bending portion 37b bent in an orthogonal direction, however a bending angle can be variously changed.

Even in the second support bar 36b, a linear portion 33a and a bending portion 33b corresponding to the first support bar 36a are provided. That is, the first and second support bars 36a and 36b are attached in an axisymmetric form to the fixing device 32. Unlike a linear type, the vibration reduction apparatus 30 comprising the bent first and second support bars 36a and 36b can reduce a vibration of a bent direction. That is, when the linear portions 37a and 33a are arranged in a Y-direction and the bending portions 37b and 33b are arranged in an X-direction, both vibrations of an X-direction and a Y-direction can be reduced.

As shown in FIG. 5, the vibration reduction apparatus 30 in another implementation of this document comprises bent first and second support bars 36a and 36b extended from the fixing device 32. However, a bending direction of the vibration reduction apparatus 30 of FIG. 5 is different from that of the vibration reduction apparatus 30 of FIG. 4. That is, the bending portions 37b and 33b are disposed in opposite directions.

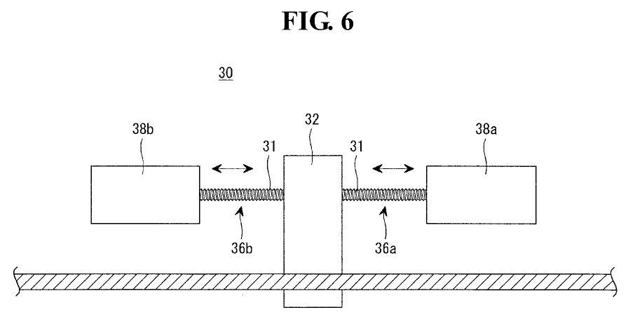

FIG. 6 is a perspective view illustrating a configuration of a vibration reduction apparatus of a disk drive in another implementation of this document.

As shown in FIG. 6, the vibration reduction apparatus 30 in another implementation of this document can adjust a distance between first and second vibration proof weights 38a and 38b and a fixing device 32. As described above, a length of first and second support bars 36a and 36b is an element related to a vibration range in which the vibration reduction apparatus 30 can reduce a vibration. Accordingly, the vibration reduction apparatus 30 in which locations of the first and second vibration proof weights 38a and 38b are adjusted can very actively correspond to a vibration. Adjustment of a location is performed when a male screw 31 formed in the first and second support bars 36a and 36b is inserted while rotating into a female screw (not shown) formed in at least one of the fixing device 32 or the vibration proof weights 38a and 38b. Adjustment of the same length can be performed as a driver (not shown) operates by a control signal generated in the controller (not shown). When a length of the support bars 36a and 36b is adjusted by the driver, the vibration reduction apparatus 30 can actively correspond to a vibration changing according to a rotation speed of a disk. That is, by appropriately adjusting a length of the support bars 36a and 36b to correspond to a low speed rotation step and a high speed rotation step of a disk, a vibration can be minimized.

The foregoing embodiments and advantages are merely exemplary and are not to be construed as limiting this document. The present teaching can be readily applied to other types of apparatuses. The description of the foregoing embodiments is intended to be illustrative, and not to limit the scope of the claims. Many alternatives, modifications, and variations will be apparent to those skilled in the art.

1. A vibration reduction apparatus comprising:
a fixing device;
a support bar extended from the fixing device and for vibrating while being elastically deformed by an external vibration; and
a vibration proof weight provided in the support bar and for giving a weight to the support bar.

2. The vibration reduction apparatus of claim 1, wherein the support bar is extended from at least one side of the fixing device and has a linear shape.

3. The vibration reduction apparatus of claim 1, wherein the support bar is extended from at least one side of the fixing device and has a shape bent at least one time.

4. The vibration reduction apparatus of claim 1, further comprising a location adjusting unit for adjusting a distance between the vibration proof weight and the fixing device.

5. A disk drive comprising:
an optical pickup base for moving an optical pickup;
a spindle motor installed at the front end of the optical pickup base to provide power required for rotating a disk and in which a turntable for mounting the disk is provided in a rotation axis; and
at least one vibration reduction apparatus in which a vibration proofweight having one side connected to a support bar of a cantilever shape is provided in at least one surface of the optical pickup base and in which the vibration proof weight is separated from one surface of the optical pickup base to absorb a vibration generated in the optical pickup base.

6. The disk drive of claim 5, wherein the vibration reduction apparatus comprises:
a fixing device fixedly installed in a surface of the optical pickup base;
a support bar extended from one side of the fixing device and having an elastically deformable cantilever shape; and
a vibration proof weight provided at the front end of the support bar.

7. The disk drive of claim 6, wherein the vibration proof weights are provided in symmetry about the support bars provided at both sides of the fixing device.

8. The disk drive of claim 6, wherein the support bar has a shape bent at least one time.

9. The disk drive of claim 6, wherein two fixing devices are installed in a surface of the optical pickup base and the vibration proof weights are supported by the support bar at a location between the fixing devices and at both sides.

10. The disk drive of claim 5, wherein the vibration reduction apparatus is provided at an opposite side of a portion in which the spindle motor is provided.

11. The disk drive of claim 10, wherein the vibration reduction apparatus is designed by one or an appropriate combination of a length, a sectional shape, and a Young's modulus of the support bar and a location and a weight of the vibration proof weight.
